(19) United States
(12) Patent Application Publication
(10) Pub. No.: US 2010/0307727 A1
(43) Pub. Date: Dec. 9, 2010

(54) HEAT EXCHANGER AND MANUFACTURING METHOD OF HEAT EXCHANGING PIPE COMPOSING IT

(75) Inventor: Tae-Sik Min, Dongjak-gu (KR)

Correspondence Address: GREER, BURNS & CRAIN, 300 S WACKER DR, 25TH FLOOR, CHICAGO, IL, 60606, US

(73) Assignee: KYUNG-DONG NAVIEN CO., LTD., Pyeongtaek-si (KR)

(21) Appl. No.: 12/741,422

(22) PCT Filed: Oct. 21, 2008
(86) PCT No.: PCT/KR2008/006227

§ 371 Date: Aug. 17, 2010

(30) Foreign Application Priority Data
Nov. 8, 2007 (KR) 10-2007-0113986

(51) Int. Cl. F28F 1/00; B23P 15/26

(52) U.S. Cl. 165/177; 29/890.053

(57) ABSTRACT

The present invention relates to a heat exchanger and a manufacturing method of a heat exchanging pipe composing it that are capable of preventing the flow of exhaust gas from being obstructed because the heat exchanging pipe is expanded and a space between the heat exchanging pipes is narrowed due to a water pressure of heating water flowing in the inside of the heat exchanging pipe. In order to implement this, according to the present invention, in a heat exchanger with a heat exchanging pipe where heating water flows therein and that has a rectangular cross section in which a width of a side being in contact with combustion gas is larger than a height, the heat exchanging pipe has a shape for offsetting deformation by previously considering deformation of the heat exchanging pipe generated by water pressure of the heating water flowing therein. According to the present invention, when the water pressure of the heating water is applied to the inside of the heat exchanging pipe, a cross section of the heat exchanging pipe is deformed to a shape ideal for exchanging heat, whereby the combustion gas can smoothly pass a space between the heat exchanging pipes.

### TECHNICAL FIELD

The present invention relates to a heat exchanger and a manufacturing method of a heat exchanging pipe composing it, and more particularly, to a heat exchanger and a manufacturing method of a heat exchanging pipe composing it that are capable of preventing the flow of combustion gas from being obstructed because the heat exchanging pipe is expanded and a space between the heat exchanging pipes is narrowed due to a water pressure of heating water flowing in the inside of the heat exchanging pipe.

### BACKGROUND ART

In general, examples of a combustor that can heat heating water flowing through the inside of a heat exchanging pipe in a combustion chamber by using a burner may include a boiler and a water heater.

That is, the boiler that is used at a general home, a public building, or the like is used for heating or hot water and the water heater heats cold water up to a predetermined temperature within a short time to allow a user to conveniently use the hot water.

Most of the combustors such as the boiler or the water heater is constituted by a system that uses oil or gas as fuel and combusts the oil or gas by means of a burner, heat water by using combustion heat generated in the course of the combustion, and supplies the heated water (hot water) by a user's request. The combustors include a heat exchanger for absorbing the combustion heat generated from the burner.

FIG. 1 is a front schematic view illustrating a structure of a known heat exchanger.

A heat exchanger 1 includes a heating water inlet 10 through which heating water flows in, a heat exchanging unit 20 that is constituted by a plurality of heat exchanging pipes 21, 22, and 23 where heat is exchanged on surfaces thereof in contact with combustion gas while the heating water flowing in from the heating water inlet 10 passes through the insides of the heating exchanging pipes 21, 22, and 23, and a heating water outlet 30 through which the heating water heated while passing through the heating exchanging pipes 21, 22, and 23 is discharged.

Both ends of each of the heat exchanging pipes 21, 22, and 23 are inserted into and coupled with pipe insertion holes penetratively formed on end plates 11 and 31. A channel of the heating water is connected to the outsides of the end plate 11 and 31 through U-shaped tubes 12 and 14.

The heat exchanging pipes 21, 22, and 23 are separated from each other by a pre-determined gap and the combustion gas passes therebetween, which results in exchanging the heat.

At this time, a difference in heat exchanging efficiency is generated depending on adjustment of the gap among the heat exchanging pipes 21, 22, and 23. When the heat exchanging pipes are densely installed by excessively narrowing the gap in order to installing more heat exchanging pipes, a flowing path of combustion gas is narrowed. Therefore, in order to prevent the problem, the number of the heat exchanging pipes and a separation gap between the heat exchanging pipes must be designed to be proper.

Meanwhile, the heat exchanger 1 having the above-mentioned structure is commonly used in the boiler or the water heater, but the boiler and the water heater are different in the water pressure of the heating water flowing through the inside of each of the heat exchanging pipes 21, 22, and 23.

That is, the water pressure in the heat exchanging pipes, which is used in the boiler is in a low pressure state of approximately 3 kg/cm², while the water pressure in the heat exchanging pipes, in which is used in the water heater is in a high pressure state of approximately 10 kg/cm². Accordingly, when the heating water flows through the insides of the heat exchanging pipes, shapes of the heat exchanging pipes used in the water heater are deformed due to a high water pressure.

FIG. 2 is a cross-sectional view of a known heat exchanging pipe. FIG. 2(a) is a cross-sectional view illustrating a state before a water pressure is applied to the inside of the heat exchanging pipe and FIG. 2(b) is a cross-sectional view illustrating a state after the water pressure is applied to the inside of the heat exchanging pipe. FIG. 3 is a state diagram illustrating a pressure when the water pressure is applied to the inside of the known heat exchanging pipe.

As shown in FIG. 2(a), in a state in which insides of heat exchanging pipes 21a, 22a, and 23a are vacant, a space where the combustion gas can smoothly pass is formed among the heat exchanging pipes 21a, 22a, and 23a, but as shown in FIGS. 2(b) and 3, in a state in which the heating water is filled with the insides of heat exchanging pipes 21b, 22b, and 23b, the heat exchanging pipes 21b, 22b, and 23b are expanded and thus the space where the combustion gas can pass is narrowed due to a difference between an internal water pressure P and an external atmospheric pressure, thereby decreasing the heat exchanging efficiency.

### DISCLOSURE OF INVENTION

### Technical Problem

The present invention is contrived to solve the above-mentioned problems. It is an object of the present invention to provide a heat exchanger with a heat exchanging pipe having a shape for offsetting deformation by previously considering deformation of the heat exchanging pipe due to a water pressure of heating water in the heat exchanging pipe which is used in the heat exchanger and a manufacturing method of a heat exchanging pipe composing it.

### Technical Solution

In order to achieve the above-mentioned object, in a heat exchanger according to the present invention, which includes a heat exchanging pipe where heating water flows therein and that has a rectangular cross section in which a width of a side being in contact with combustion gas is larger than a height, the heat exchanging pipe has a shape for offsetting deformation by previously considering deformation of the heat exchanging pipe generated by water pressure of the heating water flowing therein.

A middle portion of the side in the heat exchanging pipe has a concave shape.

According to the present invention, a manufacturing method of a heat exchanging pipe where heating water flows therein and that has a rectangular cross section in which a width of a side being in contact with combustion gas is larger than a height, a cross section of the heat exchanging pipe is deformed by applying a pressure corresponding to water pressure of heating water, which acts on the inside of the heat exchanging pipe to an outer surface of the heat exchanging pipe.

### Advantageous Effects

By a heat exchanger and a manufacturing method of a heat exchanging pipe composing it according to the present invention, a structure of the heat exchanging pipe is formed by inversely applying a pressure corresponding to a water pressure acting on the inside of the heat exchanging pipe when heating water flows, such that a cross section of the heat exchanging pipe is deformed to a shape ideal for exchanging heat when the water pressure of the heating water is applied to the inside of the heat exchanging pipe, whereby combustion gas can smoothly pass through a space between the heat exchanging pipes.

### BRIEF DESCRIPTION OF DRAWINGS

FIG. 1 is a front schematic view illustrating a structure of a known heat exchanger;

FIG. 2 is a cross-sectional view of a known heat exchanging pipe, FIG. 2(a) is a cross-sectional view illustrating a state before a water pressure is applied to the inside of the heat exchanging pipe, and FIG. 2(b) is a cross-sectional view illustrating a state after the water pressure is applied to the inside of the heat exchanging pipe;

FIG. 3 is a state diagram illustrating a pressure when the water pressure is applied to the inside of a known heat exchanging pipe;

FIG. 4 is a state diagram illustrating a pressure applied to the outside and the inside of a heat exchanging pipe in manufacturing the heat exchanging pipe according to the present invention; and

FIG. 5 is a cross-sectional view of a heat exchanging pipe according to the present invention, FIG. 5(a) is a cross-sectional view illustrating a state before a water pressure is applied to the inside of the heat exchanging pipe, and FIG. 5(b) is a cross-sectional view illustrating a state after the water pressure is applied to the inside of the heat exchanging pipe.

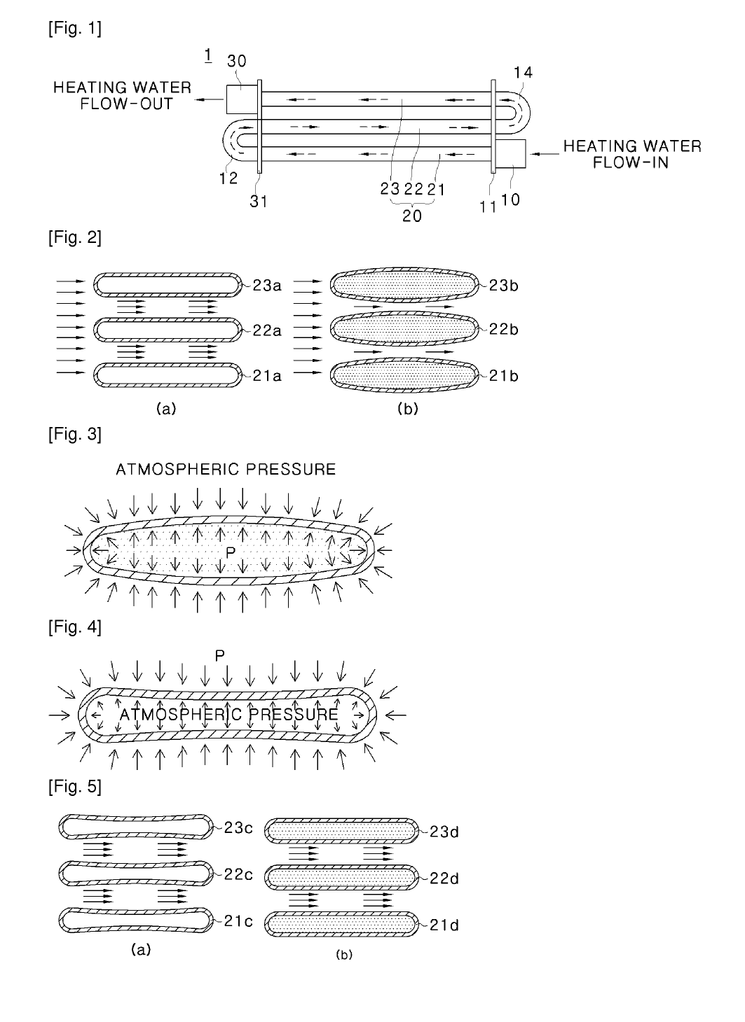

### BEST MODE FOR CARRYING OUT THE INVENTION

Hereinafter, the configuration and operation of a preferred embodiment of the present invention will be described in detail with reference to the accompanying drawings.

FIG. 4 is a state diagram illustrating a pressure applied to the outside and the inside of a heat exchanging pipe in manufacturing the heat exchanging pipe according to the present invention.

A structural characteristic of the heat exchanging pipe according to the present invention is in that expansion of the heat exchanging pipe generated due to a water pressure of heating water is offset when the heating water flows while filling in the inside of the heat exchanging pipe by activation of a combustor.

In order to form such a structure, a pressure when a water pressure is applied to a known heat exchanging pipe described in FIG. 3 is inversely applied in the present invention.

That is, in FIG. 3, when the heating water flows through the heat exchanging pipe during the combustor is activated, a water pressure P acts on the inside of the heat exchanging pipe and an atmospheric pressure acts on the outside of the heat exchanging pipe, while in FIG. 4, the atmospheric pressure acts on the inside of the heat exchanging pipe and a pressure P equal to the water pressure P of the heating water is applied to the outside of the heat exchanging pipe.

Since the pressure P is applied to the inside from the outside of the heat exchanging pipe, the heat exchanging pipe is deformed to shrink to the inside thereof by a pre-determined length. The heat exchanging pipe has a rectangular structure in which a width is larger than a height. Therefore, when the pressure P is applied to the heat exchanging pipe, a middle part of the heat exchanging pipe is deformed to a concave shape.

Accordingly, when the heat exchanging pipe is manufactured in accordance with such a deformed shape, the heat exchanging pipe is deformed to a flat cross section by the water pressure of the heating water in the case when the heating water is filled with the heat exchanging pipe, thereby promoting exchange of heat.

FIG. 5 is a cross-sectional view of a heat exchanging pipe according to the present invention, FIG. 5(a) is a cross-sectional view illustrating a state before a water pressure is applied to the inside of the heat exchanging pipe, and FIG. 5(b) is a cross-sectional view illustrating a state after the water pressure is applied to the inside of the heat exchanging pipe.

As shown in FIG. 5(a), in a state in which insides of heat exchanging pipes 21c, 22c, and 23c are vacant, a comparatively large space is formed among the heat exchanging pipes 21c, 22c, and 23c having a concave-shaped middle portion of a side being in contact with combustion gas, but as shown in FIG. 5(b), in a state in which the heating water flows while filling in insides of heat exchanging pipes 21d, 22d, and 23d, the heat exchanging pipes 21d, 22d, and 23d are expanded by the water pressure and are deformed to a flat cross section ideal for exchanging the heat.

Accordingly, the heat exchanging pipes 21d, 22d, and 23d shown in FIG. 5(b) have the same shape as heat exchanging pipes 21a, 22a, and 23a shown in FIG. 2(a).

The present invention is not limited to the embodiment, but it will be apparent to those skilled in the art that various modification and changes may be made without departing from the scopes and spirits of the present invention.

### INDUSTRIAL APPLICABILITY

As described above, the present invention is adopted in a heat exchanger of a boiler and prevents a heat exchanging pipe from being deformed due to a water pressure of heating water to allow combustion gas to smoothly flow.

1. A heat exchanger with a heat exchanging pipe where heating water flows therein and that has a rectangular cross section in which a width of a side being in contact with combustion gas is larger than a height, wherein the heat exchanging pipe has a shape for offsetting deformation by previously considering deformation of the heat exchanging pipe generated by water pressure of the heating water flowing therein.

2. A heat exchanger according to claim 1, wherein a middle portion of the side in the heat exchanging pipe has a concave shape.

3. A manufacturing method of a heat exchanging pipe where heating water flows therein and that has a rectangular cross section in which a width of a side being in contact with combustion gas is larger than a height, wherein a cross section of the heat exchanging pipe is deformed by applying a pressure corresponding to water pressure of heating water, which acts on the inside of the heat exchanging pipe to an outer surface of the heat exchanging pipe.
